(19) United States
(12) Patent Application Publication
(10) Pub. No.: US 2020/0165138 A1
(43) Pub. Date: May 28, 2020

(54) METHOD FOR MANUFACTURING ACTIVATED CARBON FOR ELECTRODE MATERIAL

(71) Applicant: TOKAI CARBON KOREA CO., LTD, Gyeonggi-do (KR)

(72) Inventor: Chang Wook SEOL, Gyeonggi-do (KR)

(73) Assignee: TOKAI CARBON KOREA CO., LTD, Gyeonggi-do (KR)

(21) Appl. No.: 16/636,922

(22) PCT Filed: Aug. 14, 2018
(86) PCT No.: PCT/KR2018/009323

§ 371 Date: Feb. 6, 2020

(30) Foreign Application Priority Data
Aug. 14, 2017 (KR) 10-2017-0103035

(51) Int. Cl. C01B 32/378; H01M 10/0525; H01M 4/587; C01B 32/348; C01B 32/318; H01G 11/34; H01G 11/86; H01G 11/24

(52) U.S. Cl. CPC C01B 32/378; H01M 10/0525; H01M 4/587; C01B 32/348; C01B 32/318; H01G 11/34; H01M 2004/021; H01G 11/24; C01P 2006/40; C01P 2006/12; C01P 2006/16; C01P 2006/14; C01P 2002/74; H01G 11/86

(57) ABSTRACT

The present invention relates to a method for manufacturing activated carbon for electrode material, and, more specifically, to activated carbon having alkali metal content of 50 ppm or less for electrode material, and to a method for manufacturing the activated carbon. The activated carbon according to the present invention can lower the activation agent content, and thus is stable and can provide improved performance

### TECHNICAL FIELD

The present invention relates to a method of manufacturing activated carbon for electrode material.

### BACKGROUND ART

With the development of electrical and electronic technology, various kinds of personal terminals and portable electronic devices have been universalized. Additionally, as researches on a hybrid electric vehicle have actively been progressed, a battery market and an application field of energy storage devices accordingly have been expanding. Recently, an energy electrochemical capacitor enabling instantaneous high-power charging and discharging by supplementing demerits of a conventional capacitor with low energy density characteristics and a secondary battery with low power density characteristics as electric energy storage devices has been researched. The electrochemical capacitor is divided into two types of an electric double layer capacitor and a similar capacitor. The electric double layer capacitor is an electrochemical capacitor which maximizes amount of electric charges charged in the capacitor according to an electrical double layer principle by using a porous material having a relatively good electrical conductivity and a very high specific surface area contacted with ions such as activated carbon as an electrode material for an anode or a cathode.

Meanwhile, technical development of the electric double layer capacitor is divided into fields of activated carbon electrode, electrolyte and separation membrane manufacturing technologies, etc. Technical development on an activated carbon electrode has been progressed mainly with respect to specific surface area, pore size distribution, pore volume, and electrical conductivity, and development has been progressed such that the activated carbon electrode has properties including a uniform voltage, an adhesive force to a current collector, a low internal resistance, etc. Recently, many researches have been progressed to investigate a correlation between pore structure and electrochemical properties of activated carbon, i.e., an electrode material of the electric double layer capacitor. It has been known according to research results that as specific surface area is increased, charging capacity is also generally increased. Further, it has been reported that, when the specific surface area is secured to a certain extent or more, an increase in fraction of mesopores has a great influence on charging capacity. Therefore, various researches have recently been progressed on a manufacturing technology of activated carbon for electrode material, the manufacturing technology which improves capacitance through a method of securing the fraction of the mesopores while maximally increasing specific surface area of activated carbon.

A method of expanding specific surface area and securing micropores has reached limits in improvable activated carbon capacitance due to characteristics of activating alkali by using carbon with a low crystallinity, and a demand for electrodes with a little higher capacitance has continuously been existed. Accordingly, a demand for a technology capable of expanding improvement of capacitance by approaching in a new way has been existed in the market.

### DISCLOSURE OF INVENTION

### Technical Subject

An object of the present invention relates to a method of manufacturing activated carbon for electrode material, the method capable of minimizing the content of an activation agent in activated carbon by using an electrodialysis machine, as a technology which has been developed to respond to the aforementioned demands.

Objects to be solved by the present invention are not limited to the above-mentioned object, and other objects that are not mentioned may be clearly understood by those skilled in the art in the following description.

### Technical Solution

One aspect of the present invention

relates to activated carbon for electrode material, the activated carbon having an alkali metal content of 50 ppm or less.

According to an embodiment of the present invention, the activated carbon may be washed within an electrodialysis machine.

According to an embodiment of the present invention, the electrodialysis machine may have a cathode application voltage of 3 V to 5 V and an anode application voltage 1.1 times to 10 times higher than the cathode application voltage.

According to an embodiment of the present invention, the activated carbon may be washed at a temperature of 20° C. to 80° C. for 10 minutes to 24 hours within the electrodialysis machine.

According to an embodiment of the present invention, the activated carbon may have a specific surface area of 300 m²/g to 1,500 m²/g, the activated carbon may have an average micropore size of 0.6 nm to 1.3 nm, and the activated carbon may have a micropore volume of 0.05 cm³/g to 0.8 cm³/g.

According to an embodiment of the present invention, the activated carbon may have an electrical conductivity of 3 S/cm to 10 S/cm.

According to an embodiment of the present invention, the activated carbon may have a maximum X-ray diffraction (XRD) peak value at 23° to 26° of an angle.

According to an embodiment of the present invention, the alkali metal may be one or more kinds of Na, K, and Ni.

The other aspect of the present invention

relates to a method of manufacturing activated carbon for electrode material, the method comprising: preparing a carbon material; carbonizing the carbon material; mixing the carbonized carbon material with an activation agent; activating the carbonized carbon material mixed with the activation agent to form activated carbon; and washing the activated carbon, wherein the step for washing the activated carbon includes washing the activated carbon by using an electrodialysis machine.

According to an embodiment of the present invention, the step for washing the activated carbon may include: washing the activated carbon with distilled water; and injecting the washed activated carbon into the electrodialysis machine to remove the activation agent.

According to an embodiment of the present invention, the step for washing the activated carbon may include: washing the activated carbon with acid; washing the activated carbon washed with acid with distilled water; and removing the activation agent by injecting the washed activated carbon into the electrodialysis machine.

According to an embodiment of the present invention, the step for removing the activation agent may be performed at a temperature of 20° C. to 80° C. for 10 minutes to 24 hours.

According to an embodiment of the present invention, the electrodialysis machine may have a cathode application voltage of 3 V to 5 V and an anode application voltage 1.1 times to 10 times higher than the cathode application voltage.

According to an embodiment of the present invention, the washed activated carbon may have a pH value of 6.5 to 7.5 after performing the step for washing the activated carbon, and the activated carbon may have an alkali metal concentration of 50 ppm or less after performing the step for washing the activated carbon.

According to an embodiment of the present invention, the carbon material may include one or more selected from the group consisting of pitch, coke, isotropic carbon, anisotropic carbon, graphitizable carbon, and non-graphitizable carbon.

According to an embodiment of the present invention, the activation agent in the step for mixing the carbonized carbon material with an activation agent is alkali hydroxides, and the activation agent may be injected at a weight ratio of 1 to 5 with respect to the carbon material.

According to an embodiment of the present invention, the activated carbon may have a specific surface area of 300 m²/g to 1,500 m²/g, the activated carbon may have an average micropore size of 0.6 nm to 1.3 nm, and the activated carbon may have a micropore volume of 0.05 cm³/g to 0.8 cm³/g.

According to an embodiment of the present invention, the activated carbon may have a maximum X-ray diffraction (XRD) peak value at 23° to 26° of an angle.

### Advantageous Effects

According to an embodiment of the present invention, the present invention can simplify a washing process of the activated carbon and can lower manufacturing costs of the activated carbon by effectively removing an activation agent remained in activated carbon by using an electrodialysis machine after performing an activation process.

According to an embodiment of the present invention, the present invention can provide activated carbon which is stable and has improved performance by enabling an activation agent content in the activated carbon to be lowered.

### BRIEF DESCRIPTION OF DRAWINGS

FIG. 1 shows a flowchart of a method of manufacturing activated carbon according to the present invention, according to an embodiment of the present invention.

### BEST MODE FOR CARRYING OUT THE INVENTION

Hereinafter, embodiments will be described in detail with reference to the accompanying drawing. In the drawing, the same reference numerals denote the same elements.

Various alterations may be applied to embodiments described below. However, the embodiments described below are not intended to limit the invention, but it should be understood that the present invention includes all the modifications, equivalents, and replacements belonging to the concept and the technical scope of the present invention. The terms used in the embodiments are intended to merely describe specific embodiments, but not intended to limit the embodiments. An expression of the singular number includes an expression of the plural number unless clearly defined otherwise in the context. In the present specification, it is to be understood that the terms such as “including, ” “having, ” etc., are intended to indicate the existence of the features, numbers, steps, operations, constituent elements, parts, or combinations thereof disclosed in the specification, and are not intended to preclude the possibility that one or more other features, numbers, steps, operations, constituent elements, parts, or combinations thereof may exist or may be added.

Unless otherwise defined, all terms, including technical and scientific terms, used herein have the same meaning as commonly understood by one of ordinary skill in the art to which embodiments pertain. Terms which are defined in a generally used dictionary should be interpreted to have the same meaning as the meaning in the context of the related art but are not interpreted as an ideally or excessively formal meaning if it is not clearly defined in the present invention.

Further, in describing the present invention with reference to the accompanying drawing, like elements will be referenced by like reference numerals or signs regardless of the drawing numbers, and description thereof will not be repeated. When it is determined that detailed description of known techniques involved in embodiments makes the gist of the embodiments obscure, the detailed description thereof will not be made.

The present invention relates to activated carbon for electrode material. According to an embodiment of the present invention, the activated carbon may provide an electrode material having stable performance since the activated carbon has exceptionally low contents of a remaining activation agent, a metal related thereto and the like.

As an embodiment of the present invention, the activated carbon may include an alkali metal in an amount range of 50 ppm or less, 30 ppm or less, or 20 ppm or less, and the alkali metal may be a constituent metal of the activation agent during manufacturing of the activated carbon. If the activated carbon includes the alkali metal within the amount range, an electrode having stable characteristics may be provided by lowering a side reaction or the like due to the alkali metal when the activated carbon is applied to an electrode material. For example, the alkali metal may include one or more of K, Na, and Li.

As an embodiment of the present invention, the activated carbon may have a particle size of 1 μm to 25 μm, and a distribution value of particles with a particle size of 5 μm to 12 μm may be 50% or more.

As an embodiment of the present invention, the activated carbon may have a specific surface area of 300 m²/g to 1,500 m²/g, and the activated carbon may have an average micropore size of 0.6 nm to 1.3 nm.

As an embodiment of the present invention, the activated carbon may have a micropore volume of 0.05 cm³/g to 0.8 cm³/g.

As an embodiment of the present invention, the activated carbon may have an electrical conductivity of 3 S/cm to 10 S/cm.

As an embodiment of the present invention, the activated carbon may have a maximum X-ray diffraction (XRD) peak value at 23° to 26° of an angle (2θ), and this increases crystallinity of the activated carbon, thereby enabling an energy storage device with a high capacitance to be provided.

According to an embodiment of the present invention, the present invention may provide an energy storage device including activated carbon according to the present invention.

As an embodiment of the present invention, an energy storage device of the present invention may include: a housing; at least one electrode including activated carbon according to an embodiment of the present invention; a separation membrane; and an electrolyte.

As an embodiment of the present invention, the energy storage device may have a capacitance of 30 F/cc to 55 F/cc.

As an embodiment of the present invention, the energy storage device may be a capacitor, a lithium secondary battery, or the like.

The present invention relates to a method of manufacturing activated carbon. According to an embodiment of the present invention, the method not only improves washing efficiency of activated carbon and reduces time of a washing process by effectively removing an alkali metal or the like from an activation-treated carbon material (or activated carbon) using an electrodialysis machine, but also can improve economic efficiency of an activated carbon manufacturing process by enabling usage capacity of acid or the like to be reduced in the washing process.

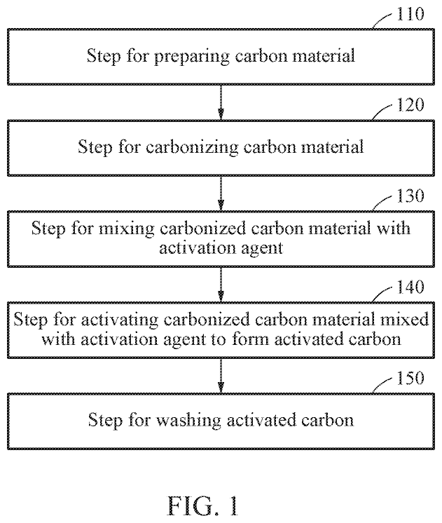

FIG. 1 exemplarily shows a flowchart of a method of manufacturing activated carbon according to the present invention, according to an embodiment of the present invention, and the method in FIG. 1 may include: step 110 for preparing a carbon material; step 120 for carbonizing the carbon material; step 130 for mixing the carbonized carbon material with an activation agent; step 140 for activating the carbonized carbon material mixed with the activation agent; and step 150 for washing the activated carbon.

As an embodiment of the present invention, step 110 for preparing a carbon material is a step for preparing a carbon material which can be used as a main material of activated carbon. For example, the carbon material may include one or more kinds selected from the group consisting of pitch, coke, isotropic carbon, anisotropic carbon, graphitizable carbon, and non-graphitizable carbon.

As an embodiment of the present invention, step 120 for carbonizing the carbon material is a step for removing elements except a carbon component and/or impurities, and others from the carbon material at high temperatures to increase crystallinity, performance, quality (e.g., purity), and others of activated carbon.

For example, step 120 for carbonizing the carbon material enables components except the carbon component to be evaporated in the form of oil vapor, and can obtain a carbonized carbon material of which weight is reduced as much as approximately 3% to 40% based on a prepared carbon material although there is a difference according to original components when the carbonization process is completed.

For example, step 120 for carbonizing the carbon material may have a carbonization temperature ranging from 600° C. to 1,200° C., from 600° C. to 1,000° C., from 600° C. to 900° C., or from 700° C. to 900° C. If the carbonization temperature is included within the temperature range, the step 120 for carbonizing the carbon material may provide activated carbon capable of implementing high capacitance as an electrode for an energy storage device while having a high XRD maximum peak angle, a high crystallinity, and a low specific surface area.

For example, step 120 for carbonizing the carbon material may be performed in an atmosphere of at least one of air, oxygen, carbon and an inert gas for 10 minutes to 24 hours. For example, the inert gas may be argon gas, helium gas or the like.

As an embodiment of the present invention, the method may further include a step for pulverizing the carbonized carbon material (not illustrated in the drawing) after performing the step 120 for carbonizing the carbon material. For example, the step for pulverizing carbonized carbon material can powder the carbonized carbon material by pulverizing the carbonized carbon material to an average particle size range of 3 μm to 20 μm. If average particle sizes of the powdered carbonized carbon material are included within the particle size range, the activation agent can be well adsorbed onto the surface of the carbon material, and activation area of the carbon material can be increased.

For example, the step for pulverizing the carbonized carbon material may be performed by using mechanical milling, and the mechanical milling may include one or more selected from the group consisting of rotor milling, mortar milling, ball milling, planetary ball milling, jet milling, bead milling, and attrition milling.

As an embodiment of the present invention, step 130 for mixing the carbonized carbon material with an activation agent is a step for mixing the carbon material carbonized in step 120 for carbonizing the carbon material with the activation agent.

For example, the activation agent is alkali hydroxides. For example, the alkali hydroxides may include KOH, and one or more kinds of NaOH and LiOH. For example, when applying a mixture of the alkali hydroxides, a weight ratio of KOH to the remainder alkali hydroxide may be 1:0.01 to 0.5; or 1:0.01 to 0.1 in order to increase activation efficiency.

For example, the activation agent may be injected to a weight ratio of 1 to 5 with respect to the carbonized carbon material. If the weight ratio is included within the aforementioned weight ratio range, activated carbon which has a low specific surface area, and of which performance such as capacitance or the like is improved may be provided.

As an embodiment of the present invention, step 140 for activating the carbonized carbon material mixed with the activation agent is a step for activating the surface of the carbonized carbon material while decomposing the activation agent by applying heat to the activation agent.

For example, step 140 for activating the carbonized carbon material mixed with the activation agent may be performed within a crucible having fine holes formed therein, and at least a portion of the activation agent may be discharged through the fine holes.

Namely, when the carbonized carbon material is activated in a general crucible (a crucible without the fine holes), the activation agent is centered and concentrated in the lower part as a melted activation agent is flown down to a lower part of the crucible. As a result, the carbonized carbon material in the lower part not only is excessively activated by a large amount of the activation agent, but also may generate a difficulty in washing the large amount of the activation agent in activated carbon, i.e., a final product. Accordingly, the present invention prevents the activation agent from being centered on the lower part and can achieve uniform activation of the carbonized carbon material by applying the crucible having the fine holes formed therein, thereby discharging the activation agent which has been flown down to the lower part of the crucible in an activation process.

For example, the fine holes in the crucible may be formed to 0.001% to 20% of the total area of the crucible, and may have a diameter of 1 μm to 1 mm

For example, the fine holes may be 1 fine hole/cm² to 200 fine holes/cm²; 8 fine holes/cm² to 150 fine holes/cm²; or 50 fine holes/cm² to 150 fine holes/cm². These fine holes discharge the activation agent at an appropriate speed, and can prevent loss of the carbonized carbon material due to discharge of the activation agent.

For example, the discharged activation agent may be reused in step 130 for mixing the carbonized carbon material with an activation agent.

For example, step 140 for activating the carbonized carbon material mixed with the activation agent

may include an activation process performed at an activation temperature of 500° C. to 1,000° C.; or 500° C. to 800° C. If the activation temperature is included within the temperature range, activated carbon which has a large specific surface area, enables the formation of micropores or the like to be made well, prevents an increase in particle sizes due to agglomeration or the like of activated carbon, and has excellent crystallinity can be provided.

For example, step 140 for activating the carbonized carbon material mixed with the activation agent may be performed for a time range of 10 minutes to 24 hours. If step 140 is performed within the time range, the step 140 allows an activation process to be sufficiently performed, and can prevent agglomeration or the like between the activated carbons due to a long-time exposure of activated carbons to high temperatures.

For example, step 140 for activating the carbonized carbon material mixed with the activation agent may be performed in an atmosphere including at least one of air, oxygen and an inert gas. For example, the inert gas may be argon gas, helium gas or the like.

For example, the activation agent may be included in the activated carbon material in an amount of 50 ppm or less after performing step 140 for activating the carbonized carbon material mixed with the activation agent.

As an embodiment of the present invention, the method may further include a step for pulverizing activated carbon (not illustrated in the drawing) after performing the step 140 for activating the carbonized carbon material mixed with the activation agent, and, for example, the step for pulverizing activated carbon can powder the activated carbon into fine particles by pulverizing the activated carbon to an average particle size range of 3 μm to 20 μm.

As an embodiment of the present invention, step 150 for washing the activated carbon is a step for washing the activation agent, metal, impurities and the like from the activated carbon after performing step 140 for activating the carbonized carbon material mixed with the activation agent.

According to an embodiment of the present invention, step 150 for washing the activated carbon may include: step 151a for washing the activated carbon with distilled water; and step 152a for removing the activation agent by injecting the washed activated carbon into an electrodialysis machine.

As an embodiment of the present invention, step 151a for washing the activated carbon with distilled water is a step for washing the activation agent, impurities and others by adding distilled water to activated carbon.

As an embodiment of the present invention, step 152a for removing the activation agent by injecting the washed activated carbon into an electrodialysis machine is a step for separating and removing the activation agent, related metals thereof, and others by injecting the activated carbon dispersed in a slurry or distilled water into the electrodialysis machine after performing step 151a for washing the activated carbon with distilled water.

For example, step 152a for removing the activation agent by injecting the washed activated carbon into an electrodialysis machine may be performed at a temperature of 20° C. to 80° C. for 10 minutes to 24 hours.

For example, in step 152a for removing the activation agent by injecting the washed activated carbon into an electrodialysis machine, the electrodialysis machine may have a cathode application voltage of 3 V to 5 V and an anode application voltage which is the same as or different from the cathode application voltage, e.g., 1.1 times to 10 times higher than the cathode application voltage.

For example, the activated carbon may have a pH value of 6.5 to 7.5 and an alkali metal concentration of 50 ppm or less after performing step 152a for removing the activation agent by injecting the washed activated carbon into an electrodialysis machine.

As an embodiment of the present invention, the method may further include a step for washing the activation agent-removed activated carbon with acid, and the step for washing the activation agent-removed activated carbon with acid is a step for additionally washing a remaining activation agent by applying an aqueous acid solution to the activated carbon after performing step 152a for removing the activation agent by injecting the washed activated carbon into an electrodialysis machine.

For example, the step for washing the activation agent-removed activated carbon with acid may be performed by applying an aqueous acid solution including one or more kinds selected from the group consisting of sulfuric acid, hydrochloric acid, nitric acid, acetic acid, formic acid, and phosphoric acid.

For example, the step for washing the activation agent-removed activated carbon with acid may be performed by applying an aqueous acid solution having a pH value of 6.5 to 7.5 and a concentration value of 0.5 mol % to 1 mol %. In the step for washing the activation agent-removed activated carbon with acid, since the activation agent is removed by using the electrodialysis machine, the remaining activation agent can be removed by applying weak acid or an aqueous acid solution with a low concentration.

For example, residual acid, an activation agent and others may be additionally removed by using distilled water and an electrodialysis machine after performing the step for washing the activation agent-removed activated carbon with acid.

According to an embodiment of the present invention, step 150 for washing the activated carbon may include: step 151b for washing the activated carbon with acid; step 152b for washing the activated carbon that has been washed with acid with distilled water; and step 153b for removing the activation agent by injecting the washed activated carbon into an electrodialysis machine.

As an embodiment of the present invention, step 151b for washing the activated carbon with acid is a step for washing the activation agent, impurities and others by applying an aqueous acid solution to the activated carbon. For example, an aqueous acid solution including one or more kinds selected from the group consisting of sulfuric acid, hydrochloric acid, nitric acid, acetic acid, formic acid, and phosphoric acid may be applied as the aqueous acid solution.

For example, step 151b for washing the activated carbon with acid is a step for primarily neutralizing and removing the activation agent remained after performing step 140 for enabling an aqueous acid solution with a pH value of 1.5 to 4 and a concentration value of 1 mol % to 5 mol % to be applied and applying an acid with the aforementioned pH value and a high concentration value to the carbonized carbon material mixed with the activation agent to activate the carbonized carbon material mixed with the activation agent. A distilled water washing process may be additionally executed after performing step 151b for washing the activated carbon with acid.

As an embodiment of the present invention, step 152b for washing the activated carbon that has been washed with acid with distilled water is a step for washing the activated carbon with distilled water after performing step 151b for washing the activated carbon with acid.

As an embodiment of the present invention, step 153b for removing the activation agent by injecting the washed activated carbon into an electrodialysis machine is a step for separating and removing the activation agent, acid, heavy metals, and others by injecting the activated carbon dispersed in a slurry or distilled water into the electrodialysis machine after performing step 152b for washing the activated carbon that has been washed with acid with distilled water.

For example, step 153b for removing the activation agent by injecting the washed activated carbon into an electrodialysis machine may be performed at a temperature of 20° C. to 80° C. for 10 minutes to 24 hours, and step 153b enables a remaining activation agent to be effectively removed to a specific content range within a short time by primarily removing the activation agent by using an aqueous acid solution.

For example, in step 153b for removing the activation agent by injecting the washed activated carbon into an electrodialysis machine, the electrodialysis machine may have a cathode application voltage of 3 V to 5 V and an anode application voltage which is the same as or different from the cathode application voltage, e.g., 1.1 times to 10 times higher than the cathode application voltage.

As an embodiment of the present invention, the washed activated carbon may have a pH value of 6.5 to 7.5 and an alkali metal concentration of 50 ppm or less, or 20 ppm or less after performing step 150 for washing the activated carbon.

According to an embodiment of the present invention, the method further includes a step for drying the washed activated carbon (not illustrated in the drawing) after performing the step 150 for washing the activated carbon, and the step for drying the washed activated carbon may include a drying process which is performed at a temperature of 50° C. to 200° C.; 80° C. to 200° C.; or 90° C. to 150° C., and is performed in an atmosphere including air, an inert gas, or both thereof.

The present invention increases washing efficiency of the activated carbon and can provide activated carbon having stable characteristics by removing an activation agent, and impurities, metals and others due to the activation agent by using an electrodialysis machine during washing of activated carbon.

Various modifications or changes from the aforementioned descriptions can be made by a person having ordinary skill in the art. For example, appropriate results can be achieved although described techniques are performed in order different from a described method, and/or described elements are joined or combined in a form different from the described method, or replaced or substituted by other elements or equivalents.

Therefore, other implementations, other embodiments, and equivalents of the scope of claims also belong to the scope of the claims described below.

1. An activated carbon for an electrode material, the activated carbon having an alkali metal content of 50 ppm or less.

2. The activated carbon for the electrode material of claim 1, wherein the activated carbon is washed within an electrodialysis machine.

3. The activated carbon for the electrode material of claim 2, wherein the electrodialysis machine has a cathode application voltage of 3 V to 5 V and an anode application voltage 1.1 to 10 times higher than the cathode application voltage.

4. The activated carbon for the electrode material of claim 2, wherein the activated carbon is washed at a temperature of 20° C. to 80° C. for 10 minutes to 24 hours within the electrodialysis machine.

5. The activated carbon for the electrode material of claim 1, wherein the activated carbon has a specific surface area of 300 m²/g to 1,500 m²/g, the activated carbon has an average micropore size of 0.6 nm to 1.3 nm, and the activated carbon has a micropore volume of 0.05 cm³/g to 0.8 cm³/g.

6. The activated carbon for the electrode material of claim 1, wherein the activated carbon has an electrical conductivity of 3 S/cm to 10 S/cm.

7. The activated carbon for the electrode material of claim 1, wherein the activated carbon has a maximum X-ray diffraction (XRD) peak value at 23° to 26° of an angle.

8. The activated carbon for the electrode material of claim 1, wherein the alkali metal is one or more kinds of Na, K, and Ni.

9. A method of manufacturing an activated carbon for an electrode material, the method comprising:
preparing a carbon material;
carbonizing the carbon material;
mixing the carbonized carbon material with an activation agent;
activating the carbonized carbon material mixed with the activation agent to form activated carbon; and
washing the activated carbon,
wherein the washing of the activated carbon comprises washing the activated carbon by using an electrodialysis machine.

10. The method of claim 9, wherein the washing of the activated carbon comprises:
washing the activated carbon with distilled water; and
injecting the washed activated carbon into the electrodialysis machine to remove the activation agent.

11. The method of claim 9, wherein the washing of the activated carbon comprises:
washing the activated carbon with acid;
washing the activated carbon washed with acid with distilled water; and
removing the activation agent by injecting the washed activated carbon into the electrodialysis machine.

12. The method of claim 9, wherein the removing of the activation agent is performed at a temperature of 20° C. to 80° C. for 10 minutes to 24 hours.

13. The method of claim 9, wherein the electrodialysis machine has a cathode application voltage of 3 V to 5 V and an anode application voltage 1.1 times to 10 times higher than the cathode application voltage.

14. The method of claim 9, wherein the washed activated carbon has a pH value of 6.5 to 7.5 after performing the washing of the activated carbon, and the activated carbon has an alkali metal concentration of 50 ppm or less after performing the washing of the activated carbon.

15. The method of claim 9, wherein the carbon material includes one or more selected from the group consisting of pitch, coke, isotropic carbon, anisotropic carbon, graphitizable carbon, and non-graphitizable carbon.

16. The method of claim 9, wherein the activation agent in the mixing of the carbonized carbon material with an activation agent is alkali hydroxides, and the activation agent is injected at a weight ratio of 1 to 5 with respect to the carbon material.

17. The method of claim 9, wherein the activated carbon has a specific surface area of 300 m²/g to 1,500 m²/g, the activated carbon has an average micropore size of 0.6 nm to 1.3 nm, and the activated carbon has a micropore volume of 0.05 cm³/g to 0.8 cm³/g.

18. The method of claim 9, wherein the activated carbon has a maximum X-ray diffraction (XRD) peak value at 23° to 26° of an angle.
